(19) United States
(12) Patent Application Publication
(10) Pub. No.: US 2008/0296014 A1
(43) Pub. Date: Dec. 4, 2008

(54) INTERVENTIONLESS COMPOSITE PACKER

(75) Inventors: BENNETT M. RICHARD, KINGWOOD, TX (US); LARRY A. WATKINS, Cypress, TX (US)

Correspondence Address: CANTOR COLBURN, LLP, 20 Church Street, 22nd Floor, Hartford, CT, 06103, US

(73) Assignee: BAKER HUGHES INCORPORATED, HOUSTON, TX (US)

(21) Appl. No.: 12/101,235

(22) Filed: Apr. 11, 2008

Related U.S. Application Data
(60) Provisional application No. 60/940,713, filed on May 30, 2007.

(51) Int. Cl. E21B 23/00; F16L 25/00

(52) U.S. Cl. 166/187; 285/381.2

(57) ABSTRACT

An element includes a tube, at least in part including a shape memory material; and a swellable material disposed adjacent the tube.

### CROSS REFERENCE TO RELATED APPLICATIONS

This application claims the benefit of an earlier filing date from U.S. Provisional Application Ser. No. 60/940,713 filed May 30, 2007, the entire disclosure of which is incorporated herein by reference.

### BACKGROUND

A pervasive necessity in industries focused on recovery of materials from below the earth's surface, for example the hydrocarbon recovery art, is to seal componentry downhole in a number of different configurations, at different pressures, temperatures, environments, and other factors. Many types of sealing devices have been developed to address particular applications and to improve overall sealing in different applications and such development has been occurring since the very beginnings of hydrocarbon exploration of recovery.

As wells continue to become more complex, further development of sealing technology is required due to such factors as instrumented completions, instrumented drilling apparatus, etc. that cause inside dimensions along a string to vary, for example.

### SUMMARY

An element includes a tube, at least in part including a shape memory material; and a swellable material disposed adjacent the tube.

A method for making a seal includes configuring a shape memory material to a shape; heating the material to above a transition temperature for the material; reconfiguring the material; cooling the material to a temperature below the transition temperature of the material; and disposing a swellable material adjacent the shape memory material.

### BRIEF DESCRIPTION OF THE DRAWINGS

Referring now to the drawings wherein like elements are numbered alike in the several Figures:

FIG. 1 is a schematic cross sectional view of an embodiment of a seal as described herein in a run in position;

FIG. 2 is a schematic cross sectional view of an embodiment of the seal as described herein in a set position;

FIG. 3 is a schematic cross-sectional view of an alternate embodiment of a seal as described herein in a run in position; and

FIG. 4 is a schematic cross-sectional view of an alternate embodiment of a seal as described herein in a set position.

### DETAILED DESCRIPTION

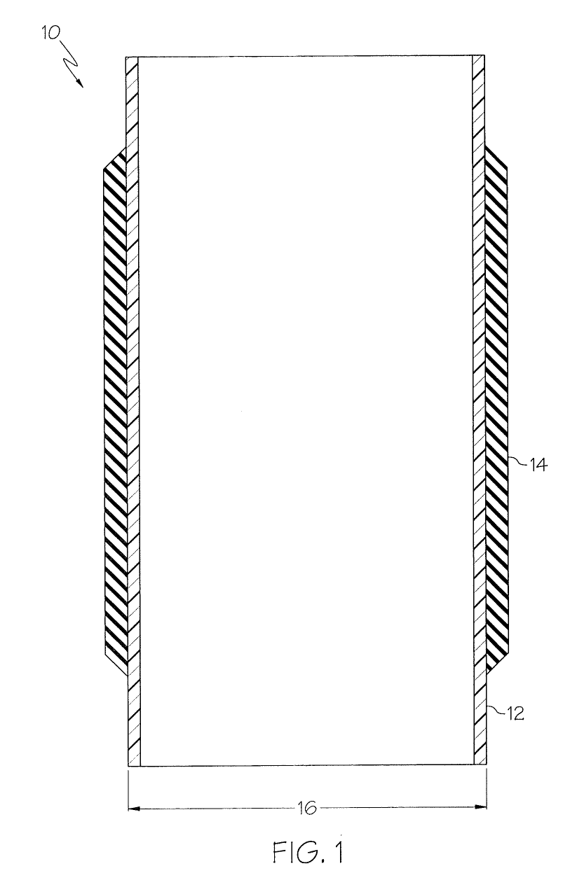

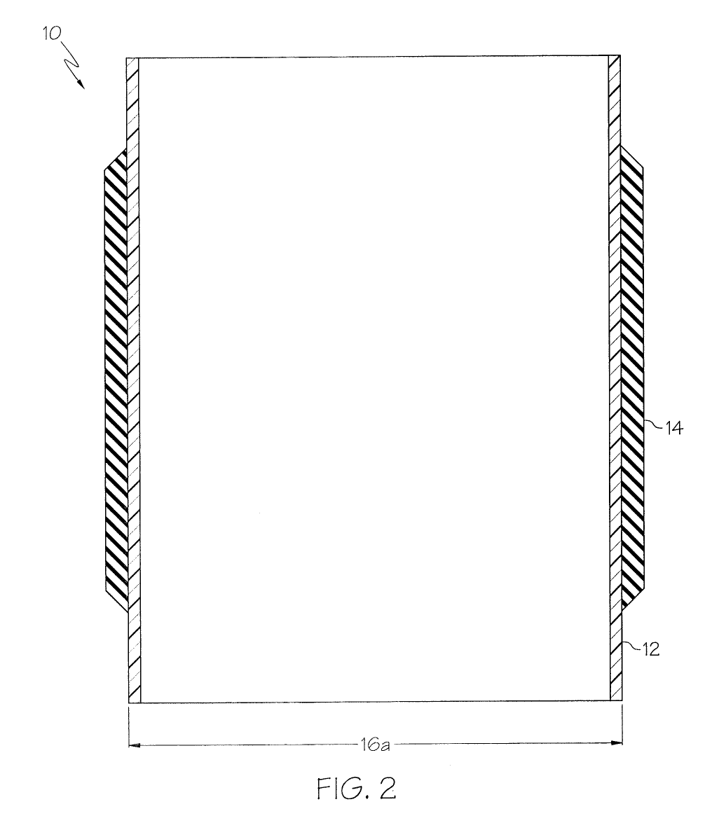

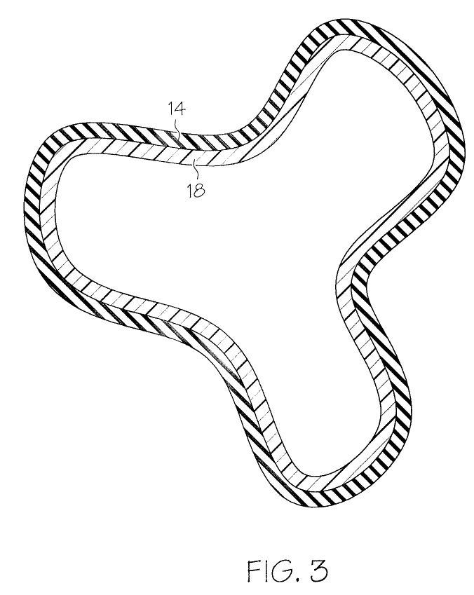

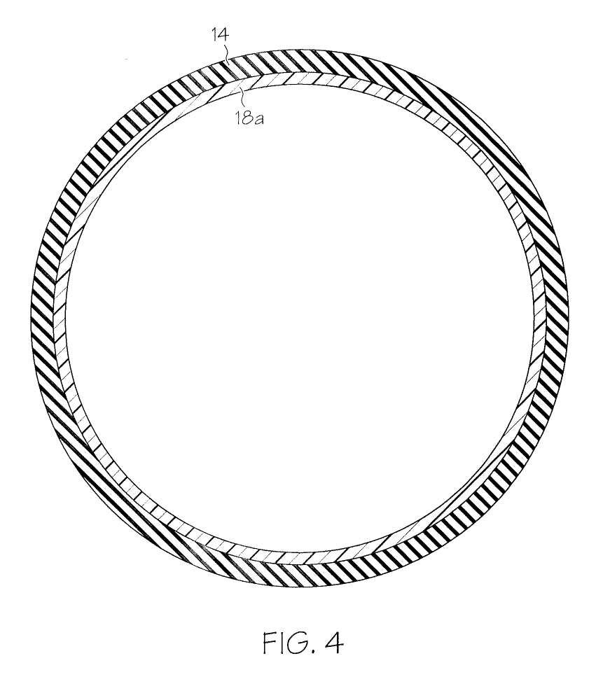

Referring to FIG. 1, an element such as a seal 10 (could also be used as an actuator) according to the disclosure hereof is illustrated in a run in position. The seal 10 comprises a tube 12, itself at least partially comprising a shape memory material around which is disposed a swellable material in the form of an element 14 as illustrated. The shape memory material is selected such that it possesses a transition temperature appropriate to the environment in which the seal 10 is to be used. More specifically the shape memory material employed conjunction with the seal 10 hereof will have in one embodiment a transition temperature somewhere between ambient environmental temperatures at a terrestrial surface location adjacent to the downhole location where the seal 10 is to be used and the prevailing temperature at the downhole location where the seal 10 is to be used. This embodiment requires no accessory heat source and relies solely on the natural heat in the wellbore for the reconfiguring property of the shape memory material to be realized. In other embodiments, accessory heat sources of any kind may be used. These will allow the material selected to have a transition temperature that is higher than ambient wellbore temperature for applications where such property would be helpful. In either case, the shape memory tube 12 is to be heated to its particular transition temperature in a controlled environment and then deformed into a desired shape. Such shape is to facilitate the installation of the seal 10 in a selected location. In one embodiment, illustrated in FIGS. 1 and 2, the shape is an elongated and diametrically thinned shape 16 and 16a to facilitate insertion of the seal 10 into the inside dimension of a target tubular, for example. Alternatively, and referring to FIGS. 3 and 4, the tube 12 is deformed into an axially corrugated shape 18 and 18a such that the outside dimensions of the tube 12 are smaller than they would be were the tube not corrugated. It should also be noted at this point that it is contemplated that the tube may not entirely consist of shape memory material as alluded to above. In fact, the tube may have selected areas thereof that comprise shape memory material in order to cause certain shape changes in certain areas of the tube while minimizing changes in other areas. Moreover, it is also contemplated that the cost of material for the seal 10 can be reduced by using less shape memory material in selected areas to still achieve the desired end result. Shape memory materials appropriate for use in connection herewith include but are not limited to proprietary polymeric materials that can be commercially acquired from Composite Tubular Development Inc, Lafayette Colorado, Nickel Titanium alloy, etc.

In each illustrated case, after the tube 12 is deformed in the desired shape or dimensions, the temperature of the tube is brought back to below the transition temperature of the shape memory material such that the shape is maintained (“frozen”). In this condition, the swellable material 14 is added thereto in a generally tubular configuration therearound. It is also contemplated to add the swellable material before the deformation of the tube 12 providing that the swellable material is tolerant of the heat required to exceed the transition temperature of the shape memory material. In this condition, the seal 10 is ready for deployment in a wellbore or other target structure. Upon installing the seal 10 in the downhole environment, and assuming that the temperature of the environment is as anticipated, or higher, or in an accessory heat source embodiment, the accessory heat source succeeds in bringing the temperature of the material back above its transition temperature, the shape memory material will reform to its original shape. In each of the illustrated embodiments, the “remembered” shape is of larger outside dimensions thereby facilitating the creation of a force against on outer tubular which may be employed as a seal force or an actuation force. The swellable material 14, being disposed radially outwardly of the tube 12, in this embodiment, will be urged into contact with an outer tubular when the shape memory material regains its original shape. Further, because the swellable material element 14 is indeed swellable, exposure thereof to an appropriate swelling fluid (water, oil, etc.) will swell the element 14 and thereby create a greater force, which may be a tighter seal or a greater actuation force, for example, between the tube 12 and the outer tubular in which the element 10 is set.

In one embodiment, the swellable material is a composite material including portions thereof swellably responsive to a number of different swelling fluids. Such a composite swellable material increases the chances that a seal or actuation force will be effected by ensuring that the material will react to at least one of the fluids in the wellbore at any given time. In one embodiment, the swellable material element comprises portions responsive to contact with water, portions responsive to oil and portions responsive to methane. The swellable material will thus have a very high likelihood of swelling in a downhole environment as seldom will all of the three noted swelling fluids be absent.

Although the discussion above is directed to a seal 10 or actuator that operates with radially outward expansion, the concept hereof is reversible such that the shape memory material is configured to regain a smaller diametrical dimension to urge a swellable material disposed on the inside dimension thereof to be forced against a more radially inwardly located component, whereafter, swelling of the swellable material will create more radially inwardly directed force. Additionally, it is to be appreciated that although the foregoing discussion relates to radial expansion, the concept of combining a shape memory material and a swellable material for the purpose of for example sealing or actuation is not limited to radial expansion. Rather, the expansion can be in any direction. For example, the shape memory material may change in length and the swellable material may be configured to swell in the same direction for a lengthwise actuation. Further, the shape may be any geometric shape obtainable with shape memory material and the swellable material may be positioned and configured to enhance the motion provided by the shape material or may be positioned and configured to swell in a different direction or shape.

While preferred embodiments have been shown and described, modifications and substitutions may be made thereto without departing from the spirit and scope of the invention. Accordingly, it is to be understood that the present invention has been described by way of illustrations and not limitation.

1. An element comprising:
a tube, at least in part including a shape memory material; and
a swellable material disposed adjacent the tube.

2. The element as claimed in claim 1, wherein the swellable material is radially adjacent the tube.

3. The element as claimed in claim 2, wherein the swellable material is radially outwardly disposed.

4. The element as claimed in claim 2, wherein the swellable material is radially inwardly disposed.

5. The element as claimed in claim 1, wherein the swellable material is a composite swellable material responsive to more than one swelling fluid.

6. The element as claimed in claim 5, wherein the swellable material is responsive to water and at least one other swelling fluid.

7. The element as claimed in claim 5, wherein the swellable material is responsive to oil and at least one other swelling fluid.

8. The element as claimed in claim 5, wherein the swellable material is responsive to methane and at least one other swelling fluid.

9. The element as claimed in claim 1 wherein the sealable material is responsive to water only.

10. The element as claimed in claim 1 wherein the sealable material is responsive to oil only.

11. The element as claimed in claim 1 wherein the sealable material is responsive to methane only.

12. A method for making a seal comprising:
configuring a shape memory material to a shape;
heating the material to above a transition temperature for the material;
reconfiguring the material;
cooling the material to a temperature below the transition temperature of the material; and
disposing a swellable material adjacent the shape memory material.

13. The method as claimed in claim 12 further comprising:
running the shape memory material and swellable material to a target location; and
heating the shape memory material to a temperature above the transition temperature of the shape memory material thereby regaining an original shape of the shape memory material.

14. The method as claimed in claim 13 further comprising exposing the swellable material to a swelling fluid to which the swellable material is responsive.

15. The method as claimed in claim 12 wherein the reconfiguring is extending and thinning.

13. The method as claimed in claim 12 wherein the reconfiguring is corrugating.

14. The method as claimed in claim 12 wherein the corrugating is axial.
